(19) United States
(12) Patent Application Publication
(10) Pub. No.: US 2026/0347265 A1
(43) Pub. Date: Nov. 5, 2026

(54) MACHINABLE COATINGS FOR SEALING AND BEARING FEATURES ON CMC COMPONENTS

(71) Applicant: RTX CORPORATION, Farmington, CT (US)

(72) Inventor: David A. LITTON, West Hartford, CT (US)

(73) Assignee: RTX CORPORATION, Farmington, CT (US)

(21) Appl. No.: 19/665,818

(22) Filed: May 1, 2026

Related U.S. Application Data
(60) Provisional application No. 63/799,083, filed on May 2, 2025.

(51) Int. Cl. C04B 35/565; C04B 41/50; C04B 41/53; F01D 11/08; F01D 25/16; F02K 3/06

(52) U.S. Cl. CPC C04B 35/565; C04B 41/5032; C04B 41/53; F01D 11/08; F01D 25/162; F02K 3/06; C04B 2235/3826; C04B 2235/5244; C04B 2235/963; F05D 2240/56; F05D 2300/2261; F05D 2300/514; F05D 2300/516; F05D 2300/6033; F05D 2300/611

(57) ABSTRACT

A ceramic matrix composite (CMC) component is described having a coating on a non-gaspath surface. The machinable coating contains CaAl₄O₇, also known as grossite or Ca-dialuminate. To enhance durability and the ability to provide a smooth surface, the machinable coating can have a relatively low-porosity, for example, a porosity of ≤ 25 vol. %. Also, to improve CTE match with SiC-containing materials, the machinable coating can have a relatively high CaAl₄O₇ content, for example ≥ 75 vol. % CaAl₄O₇. The thickness of the CaAl₄O₇ machinable coating can be, for example, up to about 2,500 μm.

### FIELD OF THE INVENTION

The subject matter disclosed herein relates to ceramic coatings used in high temperature environments, and, in particular, relates to coatings used on as gas turbine engine components.

### BACKGROUND OF THE INVENTION

Gas turbine engines, in general, include a fan section, a compressor section, a combustion section, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Thus, turbomachinery, such as gas turbine engines, have components such as turbine blades, turbine airfoils, blade outer air seals, and combustor liners that are exposed to hostile environments due to high temperatures. Therefore, it is desirable that such components be made of heat resistant materials such as superalloys or ceramic matrix composites (CMCs). While CMC materials can withstand much higher operating temperatures than superalloys, components made from both of these materials can be provided with coatings to enhance their ability to withstand high temperatures and/or to protect the underlying substrates from the corrosive nature of the high-energy, high temperature gas flow.

For example, jet engine components having a CMC substrate can be provided with environmental barrier coatings (EBCs) applied to the surface thereof to protect the substrate from corrosive forces due to, for example, exposure to high temperature water vapor. EBC coating systems are typically dense coatings, i.e., exhibit low porosity, in order to minimize vapor permeability.

A further type of coating used in turbomachinery such as jet engines are thermal barrier coatings (TBC). TBCs are applied to components having CMC or superalloy substrates that are exposed to high temperatures. TBCs are ceramic coatings that exhibit very low thermal conductivity and thus protect the underlying substrate to which they are applied from excessive temperatures.

In addition to protective coatings such as EBCs and TBCs, components can be provided with machinable coatings. These are coatings that can be easily machined to achieve certain desirable surface characteristics, e.g., smoothness. For example, such machined coatings can be used to provide sealing or bearing surfaces for interaction with metallic or metal-containing components during operation. While EBCs and TBCs are applied to surfaces exposed to the hot gaspath, machinable coatings can be applied to non-gaspath surfaces.

Coatings such as EBCs, TBCs, and machinable coatings can be prepared by thermal spraying such as plasma spraying using powders to form deposited layers on the substrate being treated. Typical thermal spraying processes include air or atmospheric plasma spraying (APS), vacuum plasma spraying (VPS), low pressure plasma spraying (LPPS), shrouded plasma spraying, suspension plasma spraying (SPS), and hybrid forms thereof. Ceramic coatings prepared by such methods often contain amorphous phases, as opposed to crystalline phases, in the deposited state, especially silicates. Once deposited, an additional thermal exposure above the crystallization temperature is required to sinter the coating into a stable crystalline ceramic phase.

The crystallization process (amorphous-crystalline phase transformation) for ceramics can involve notable shrinkage. This shrinkage can cause microcracking within the coating as well as formation of larger vertical or horizontal cracks. For coatings exposed to hot gases (e.g., EBCs and TBCs), microcracks provide a quick access path for hot gases and oxidative species to reach the underlying material and thus are detrimental to the performance of such coatings.

Microcracks can also cause problems for coatings not exposed to hot gases such as machinable coatings. For example, the presence of such microcracks can lead to coating delamination thus reducing the operational lifespan of the machinable coatings and of the underlying component. Similarly, a large difference in coefficients of thermal expansion (CTE mis match) between a machinable coating and the underlying CMC component can also lead to crack formation and delamination.

There exists a continuing need for materials, methods, and techniques for producing machinable coatings that can enhance the properties of such coatings and/or facilitate the manufacture thereof.

### SUMMARY OF THE INVENTION

In general, the present disclosure relates to coating compositions that exhibit reduced crack formation during crystallization. In particular, the present disclosure relates to the inclusion of agents that modify the chemistry of coatings applied by thermal spray and thereby ameliorate crack formation.

The present disclosure is directed, in a first aspect, to a method of providing a sealing surface on a non-gaspath surface of a ceramic matrix composite (CMC) component, comprising: providing a CMC component having a gaspath surface and a non-gaspath surface; applying a machinable coating containing CaAl₄O₇ to at least a portion of the non-gaspath surface of the CMC component; and machining the coating to provide a smoothened surface suitable as a sealing surface or bearing surface.

In yet another embodiment, the present disclosure is directed to a ceramic matrix component (CMC) comprising: a CMC component comprising a substrate wherein the substrate has a gaspath surface and a non-gaspath surface; and a coating containing CaAl₄O₇ on at least a portion of the gaspath surface of the CMC component; wherein a top surface of the CaAl₄O₇ coating is smoothened by machining to provide a surface suitable for sealing.

In yet another embodiment, the present disclosure is directed to a turbine engine comprising: A CMC component comprising a substrate wherein the substrate has a gaspath surface and a non-gaspath surface; wherein the CMC component has a coating containing CaAl₄O₇ on at least a portion of the gaspath surface of the CMC component, and a top surface of the CaAl₄O₇ coating is smoothened by machining to provide a surface suitable for sealing. a fan section, a compressor section, a combustion chamber, and a turbine section, the turbine section including at least one rotor and one or more turbine blade(s) extending radially outwardly from the at least one rotor; and

In further embodiments of the present disclosure, including further embodiments of the above exemplary embodiments, the CMC component comprises SiC fibers within a SiC matrix.

In further embodiments of the present disclosure, including further embodiments of the above exemplary embodiments, the CMC component comprises a substrate containing SiC fibers within a SiC matrix and a bond coat layer, wherein the machinable coating is applied to the bond coat layer.

In further embodiments of the present disclosure, including further embodiments of the above exemplary embodiments, the bond coat layer contains silicon metal.

In further embodiments of the present disclosure, including further embodiments of the above exemplary embodiments, the machinable coating has a porosity of ≤ 25 vol. %.

In further embodiments of the present disclosure, including further embodiments of the above exemplary embodiments, the machinable coating has a porosity of ≤ 10 vol. %.

In further embodiments of the present disclosure, including further embodiments of the above exemplary embodiments, the machinable coating contains ≥ 75 vol. % CaAl₄O₇.

In further embodiments of the present disclosure, including further embodiments of the above exemplary embodiments, the machinable coating contains ≥ 90 vol. % CaAl₄O₇.

In further embodiments of the present disclosure, including further embodiments of the above exemplary embodiments, the thickness of the machinable coating is up to about 2,500 μm.

In further embodiments of the present disclosure, including further embodiments of the above exemplary embodiments, the thickness of the machinable coating is 500 to 2,000 μm.

In further embodiments of the present disclosure, including further embodiments of the above exemplary embodiments, the smoothened surface has a roughness Rz of less than 2.0 μm.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 schematically illustrates a partial cross section of an exemplary gas turbine engine; and

FIG. 2 is a schematic illustration of a cross sectional view of brush seals attached to a BOAS segment having machinable coatings.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by volume percent (vol. %.) based on a total volume of the composition unless otherwise indicated.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

The present disclosure provides a machinable coating for use in sealing surfaces and bearing surfaces of CMC components. In particular, the machinable coating comprising CaAl₄O₇, also known as grossite or calcium dialuminate.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces in the direction toward the flow of the hot gases, i.e., faces upstream. The trailing edge/portion of a structure is the edge/portion that the faces in the direction away from the flow of the hot gases, i.e., faces downstream.

In addition, gaspath surface(s) refers to surfaces that are exposed to the high-energy, high temperature gas flow. Conversely, non-gaspath surface(s) refers to surfaces that are not exposed to the high-energy, high temperature gas flow. For example, a blade outer air seal (BOAS) can have an inner radial surface which is exposed to the high-energy, high temperature gas flow, i.e., a gaspath surface, and an outer radial surface which is not exposed to the high-energy, high temperature gas flow, i.e., a non-gaspath surface.

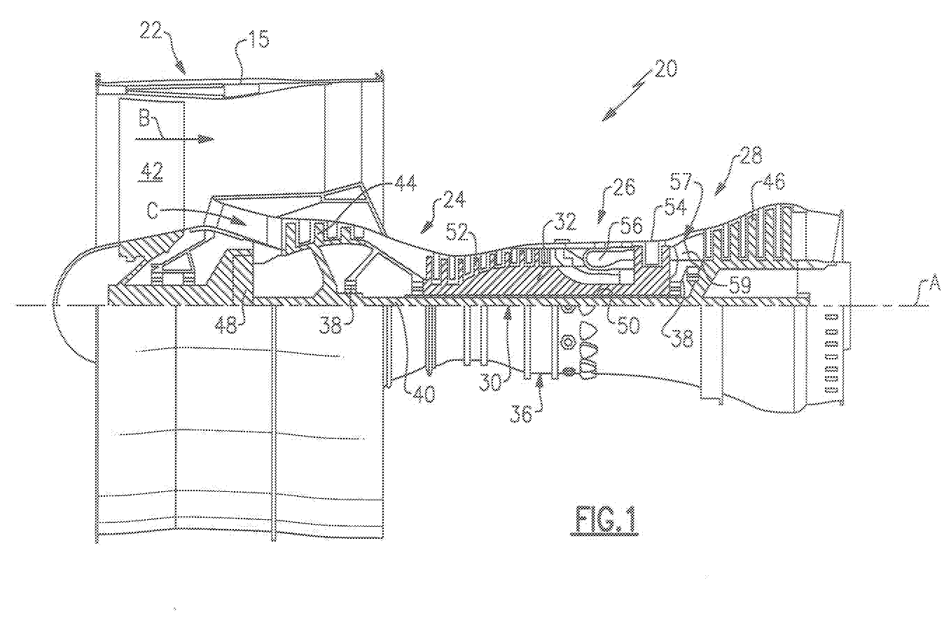

FIG. 1 schematically illustrates an example of a gas turbine engine 20 (i.e., a two-spool turbofan) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine engine, it should be understood that the concepts described herein are not limited to use with two-spool turbofans engines and may be applied to other types of turbine engines.

Engine 20 generally includes a low speed spool 30 and a high-speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

Within the combustion section, and all sections downstream thereof, jet engine components are exposed to high temperature gas flow, and, in some cases, a corrosive gas flow, i.e., the gaspath. CMCs are also used in manufacturing of jet engine components, particularly components that have at least one surface exposed to the high temperature gas flow. In comparison to superalloys, CMC materials are light weight (about 1/3 the weight of superalloys) and can withstand even higher operating temperatures.

In general, these CMC components are prepared by first creating a CMC preform which serves as the initial framework for creating the CMC component. The preform contains a stack of fabric sheets or plies in which the stack is formed via a layup process. The plies are made from ceramic fibers, or bundles of ceramic fibers called tows, held together with a binder. The fiber tows can be in the form of unidirectional tows or can be woven fibers. For example, the fibers can be woven into a two-dimensional fabric sheet or ply and then the plies are stacked during the layup process to form the preform. Alternatively, the preform can be in the form of a three-dimensional weave wherein, for example, a plurality of warp fibers are interwoven through a plurality of weft fiber layers. Binders can be used to help hold the fibers/plies together to provide a certain rigidity to the preform, for example, polymeric binders such as polyvinyl alcohol (PVA) or polyvinyl butyral (PVB).

The fibers/filaments used in the CMC preforms may be, for example, silicon carbide (SiC), carbon, mullite, zirconium carbide (ZrC), hafnium carbide (HfC), silicon nitride, aluminum oxide, or combinations thereof. The ceramic fibers may also be oxycarbide-, oxynitride-, carbonitride-, silicate-, boride-, phosphide-, or oxide-based fibers. In still further examples, the fibers are fully crystalline, partially crystalline, or predominantly amorphous or glassy. In one particular example, the fibers are SiC fibers.

The fibers of the preform can, optionally, be provided with one or several interphases deposited prior to introduction of a matrix material into the preform. This interphase coating can be, for example, a coating of boron nitride, silicon-doped boron nitride, boron-doped carbon, boron carbide, titanium nitride, or zirconium nitride which is applied by chemical vapor infiltration (CVI). The interphase coating(s) is used to prevent crack formation and/or propagation.

After the CMC preform is formed by the layup, the preform is subjected to densification to add matrix material to fill the remaining void spaces within the preform. This procedure stiffens and strengthens the fiber layers or woven plies of ceramic fiber tows to form the CMC. Thus, densification involves reducing the porosity within the preform, making it more solid and robust, by filing the remaining pores within the preform. The goal is to achieve a higher relative density, and ensure that the final CMC structure is compact and free of large voids. In one particular example, the CMC material contains SiC fibers within a SiC matrix, also referred to as a SiC/SiC composite.

Various methods can be used to add matrix material during densification. These include, but are not limited to, chemical vapor infiltration (CVI), chemical liquid-vapor deposition (CLVD), melt infiltration (MI) (such as liquid silicon infiltration (LSI)), and polymer infiltration and pyrolysis (PIP). Chemical vapor infiltration (CVI) involves introducing gaseous precursors into the porous CMC preform. These precursors react at the surface of the fibers, depositing additional material and filling the voids. Chemical liquid-vapor deposition uses liquid precursors that vaporize and infiltrate the preform. The liquid-to-vapor conversion occurs at the fiber surface, leading to densification. Liquid silicon infiltration utilizes liquid (molten) silicon to infiltrate the CMC preform. Silicon reacts with carbon or other constituents of the CMC preform, forming a dense matrix. In polymer infiltration and pyrolysis, a polymer precursor is infiltrated into the preform. The subsequent pyrolysis process converts the polymer into a ceramic matrix. During pyrolysis the matrix shrinks leading to microcracks, which require repeating the polymer and infiltration cycle multiple times.

As discussed above, surfaces of CMC components that are exposed to high temperature gas flow, i.e., gaspath surfaces, can be provided with protective coatings such as EBCs and TBCs. But, additionally, non-gaspath surface of CMC components can be provided with coatings to enhance surface properties. As noted above, machinable coatings can be applied to non-gaspath surface of CMC gas turbine engine components to provide desirable surface characteristics. For example, machinable coatings can be applied to non-gaspath surfaces to provide smoothness for facilitating sealing or to provide bearing surfaces.

For example, as noted above, a blade outer air seal (BOAS) can have an outer radial surface which is not exposed to the high-energy, high temperature gas flow, i.e., a non-gaspath surface. This outer radial surface, at least in part, can be provided with a machinable coating that can be used as a sealing surface for, e.g., a brush seal. Other components that can have a smooth machinable coating are, for example, non-gaspath surfaces of combustor liners, vane platforms and blade platforms. Smooth sealing surfaces can be used for CMC components that interact with, for example, brush seals, W seals, and feather seals. Additionally, parts of CMC components that make contact with static parts containing nickel such as support hardware can be provided with machinable coatings. These machinable coatings provide a bearing surface that reduce or eliminate deleterious interactions between the Ni and the CMC material.

The machinable coating can be applied directly to the CMC substrate. Alternatively, the CMC substrate can be provided with a bond coat for enhancing adherence of the machinable coating to the substrate. The bond coat layer can be a Si-containing material such as silicon, silicon carbide, silica, silicates, and silicides, for example, a silicon metal with one or more additives such as Al, Mg, Ba, Ca, B, and/or Na.

In accordance with the present disclosure, the machinable coating contains CaAl₄O₇, also known as grossite or Ca-dialuminate. To enhance durability and the ability to provide a smooth surface needed for sealing or a protective bearing surface, it is desirable for the machinable coating containing CaAl₄O₇ to have a relatively high density, i.e., low-porosity. For example, the CaAl₄O₇ machinable coating can have a porosity of ≤ 25 vol. % such as ≤ 20 vol. % or ≤ 15 vol. % or ≤ 10 vol. % or ≤ 7.5 vol. % or ≤ 5 vol. %.

Additionally, it is desirable for the machinable coating to have a coefficient of thermal expansion that is comparable to that of the CMC substrate and/or that of a bond coat positioned between the CMC substrate and the machinable coating. As noted above, the bond coat layer can be a Si-containing material such as silicon, silica, silicates, and silicides, for example, a silicon metal with one or more additives such as Al, Mg, Ba, Ca, B, and/or Na. Machinable coatings containing CaAl₄O₇ have a CTE which is comparable to that of such bond coat materials.

Many CMC substrate and bond coat materials have high SiC contents and CaAl₄O₇ has a CTE comparable to SiC. Therefore, it can be desirable for the machinable coating to have a relatively high CaAl₄O₇ content to minimize development of thermal stresses with such materials. For example, the machinable coating can contain ≥ 75 vol. % CaAl₄O₇, for example, ≥ 80 vol. % or ≥ 85 vol. % or ≥ 90 vol. % or ≥ 95 vol. % or ≥ 97 vol. % or ≥ 98 vol. % or≥ 99 vol. %. The remainder of the machinable coating can be made up of other phases of calcium aluminate or may can be made up of other materials such as mullite.

The thickness of the CaAl₄O₇ machinable coating can vary. For example, the thickness of the CaAl₄O₇ machinable coating can be up to about 2,500 μm, such as 100 to 2,500 μm, 500 to 2,500 μm, or 500 to 2,000 μm, or 500 to 1,500 μm.

The machinable coatings can be applied to a CMC substrate by a variety of techniques. For example, the layers may be applied by various thermal spraying techniques such as atmospheric (or air) plasma spray (APS), vacuum plasma spraying (VPS), low pressure plasma spray (LPPS), suspension plasma spraying (SPS), high velocity oxygen fuel spraying (HVOF), high velocity air fuel spraying (HVAF) chemical vapor deposition (CVD), physical vapor deposition (PVD), electron beam-physical vapor deposition (EB-PVD), and plasma-spray physical vapor deposition (PS-PVD). In one embodiment, the machinable coating is applied by APS.

As mentioned above, machinable coatings can be prepared by thermal spraying (e.g., plasma spraying) using powder. Once deposited on a substrate, thermal exposure above the crystallization temperature can be utilized to sinter the coating and transform any amorphous phases in the coating to crystalline phases. During the sintering and crystallization process, however, microcracks as well as larger cracks can form as a result of shrinkage which will reduce the effectiveness and operational lifespan of the coating.

Compared to prior machinable coatings, a CaAl₄O₇ coating without appreciable amounts of silica (e.g., less than 10 vol.%) can have a higher crystallinity as-deposited by, for example, APS. As a result, when heat treated to fully crystallize the CaAl₄O₇ coating, the resultant coating will experience less shrinkage, thus less reducing microcrack formation and increasing durability.

The application of the machinable coatings compensates for the roughness of CMC substrate surface. The substrate surface can be rough due to distortion resulting from removal of binder from the fiber plies, or due to high temperatures during processing. For example, CMC materials produced using CVI densification tend to be rougher than CMC materials produced using MI densification. Once the machinable coating is applied, the coating can be smoothed by mechanical processing, for example, mechanical grinding, milling, or belt sanding. For example, the machinable coating can be applied at an initial thickness of 1,500 μm and then machined down to 1,000 μm. The final coating can, for example, have a surface roughness, Rz, of less than 2.0 μm, for example, ≤ 1.8 μm or ≤ 1.6 μm or ≤ 1.5 μm or ≤ 1.2 μm.

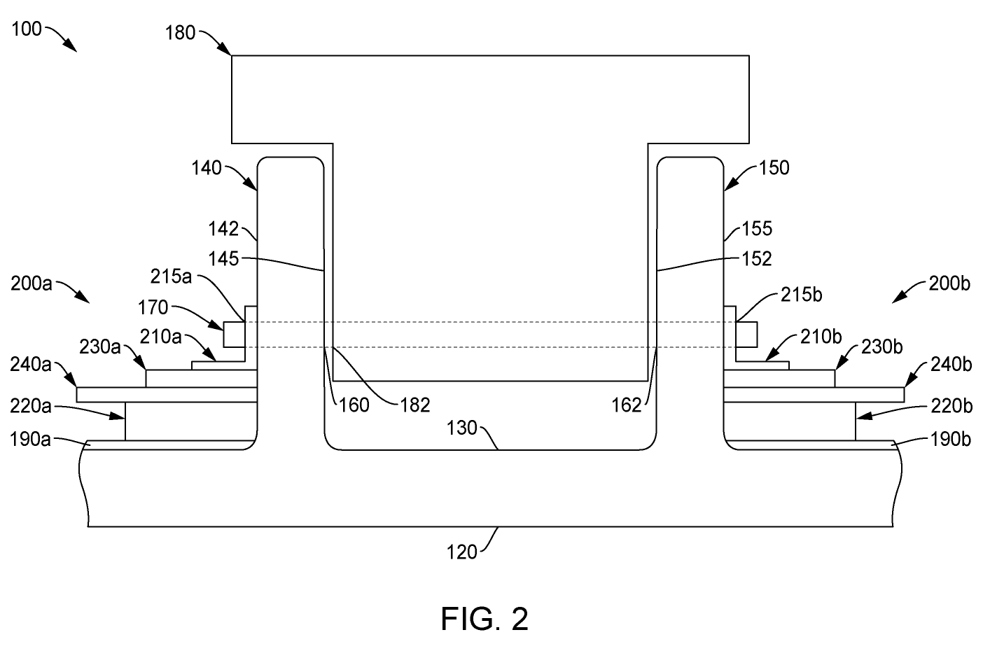

FIG. 2 illustrates an example of a CMC component with a machinable coating. FIG. 2 schematically illustrates a side view of a BOAS segment 100 having two brush seals 200a and 200b attached thereto. BOAS segment 100 has a radial inner surface 120 and a radial outer surface 130. Extending from the radial outer surface 130 are two flanges, i.e., a forward flange 140 and an aft flange 150. Flange 140 and flange 150 each have a forward surface 142, 152, respectively, and an aft surface 145, 155, respectively. Flanges 140 and 150 also each have an opening 160, 162, respectively, through which an alignment pin or axial retention pin 170 extends. The alignment pin or axial retention pin 170 also passes through the static support hardware 180 via opening 182.

Brush seals 200a and 200b each comprise a metal assembly tab 210a and 210b, an inner diameter backing plate 220a and 220b, an outer diameter backing plate 230a and 230b, and brush seal bristles 240a and 240b. Each metal assembly tap 210a and 210b has an opening 215a, 215b, respectively, through which the alignment pin or axial retention pin 170 passes. Metal assembly tab 210a rests against the forward surface 142 of forward flange 140, and metal assembly tap 210b rests against the aft surface 155 of aft flange 150. Brush seals 200a and 200b each rests against the radial outer surface 130 of the BOAS segment 100. The regions of the radial outer surface 130 of the BOAS segment 100 that contact the brush seals 200a and 200b are provided with a CaAl₄O₇ machinable coating 190a, 190b, respectively.

The CaAl₄O₇ machinable coatings according to the present disclosure provide a durable coating for sealing surfaces and bearing surfaces of CMC components such as BOAS. These CaAl₄O₇ machinable coatings exhibit CTEs which are comparable to SiC-containing CMC materials and bond coats, thus minimizing development of thermal stresses.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method of providing a sealing surface on a non-gaspath surface of a ceramic matrix composite (CMC) component comprising:
providing a CMC component having a gaspath surface and a non-gaspath surface;
applying a machinable coating containing CaAl₄O₇ to at least a portion of the non-gaspath surface of the CMC component; and
machining the coating to provide a smoothened surface suitable as a sealing surface or bearing surface.

2. The method according to claim 1, wherein the CMC component comprises SiC fibers within a SiC matrix.

3. The method according to claim 1, wherein the CMC component comprises a substrate containing SiC fibers within a SiC matrix and a bond coat layer, wherein the machinable coating is applied to the bond coat layer.

4. The method according to claim 3, wherein the bond coat layer contains silicon metal.

5. The method according to claim 1, wherein the machinable coating has a porosity of ≤ 25 vol. %.

6. The method according to claim 1, wherein the machinable coating has a porosity of ≤ 10 vol. %.

7. The method according to claim 1, wherein the machinable coating contains ≥ 75 vol. % CaAl₄O₇.

8. The method according to claim 1, wherein the machinable coating contains ≥ 90 vol. % CaAl₄O₇.

9. The method according to claim 1, wherein the thickness of the machinable coating is up to about 2,500 μm.

10. The method according to claim 1, wherein the thickness of the machinable coating is 500 to 2,000 μm.

11. The method according to claim 1, wherein the smoothened surface has a roughness Rz of less than 2.0 μm.

12. A ceramic matrix component (CMC) comprising:
a CMC component comprising a substrate wherein the substrate has a gaspath surface and a non-gaspath surface; and
a coating containing CaAl₄O₇ on at least a portion of the gaspath surface of the CMC component;
wherein a top surface of the CaAl₄O₇ coating is smoothened by machining to provide a surface suitable for sealing.

13. The component according to claim 12, wherein the CMC component comprises SiC fibers within a SiC matrix.

14. The component according to claim 12, wherein the CMC component comprises a substrate containing SiC fibers within a SiC matrix and a bond coat layer containing SiC, wherein the machinable coating is applied to the bond coat layer.

15. The component according to claim 12, wherein the machinable coating has a porosity of ≤ 25 vol. %.

16. The component according to claim 12, wherein the machinable coating contains ≥ 75 vol. % CaAl₄O₇.

17. The component according to claim 12, wherein the thickness of the machinable coating is up to about 2,500 μm.

18. A turbine engine comprising:
a fan section, a compressor section, a combustion chamber, and a turbine section, the turbine section including at least one rotor and one or more turbine blade(s) extending radially outwardly from the at least one rotor; and
a CMC component comprising a substrate wherein the substrate has a gaspath surface and a non-gaspath surface;
wherein the CMC component has a coating containing CaAl₄O₇ on at least a portion of the gaspath surface of the CMC component, and a top surface of the CaAl₄O₇ coating is smoothened by machining to provide a surface suitable for sealing.

19. The turbine engine according to claim 18, wherein the machinable coating has a porosity of ≤ 25 vol. %.

20. The turbine engine according to claim 18, wherein the machinable coating contains ≥ 75 vol. % CaAl₄O₇.
